(19) United States
(12) Patent Application Publication
(10) Pub. No.: US 2008/0181398 A1
(43) Pub. Date: Jul. 31, 2008

(54) METHODS AND APPARATUS FOR ENHANCING PRIVACY OF OBJECTS ASSOCIATED WITH RADIO-FREQUENCY IDENTIFICATION TAGS

(76) Inventor: Ravikanth Pappu, Cambridge, MA (US)

Correspondence Address: CHOATE, HALL & STEWART LLP, TWO INTERNATIONAL PLACE, BOSTON, MA, 02110, US

(21) Appl. No.: 11/627,781

(22) Filed: Jan. 26, 2007

(51) Int. Cl. H04L 9/28; H04L 9/00

(52) U.S. Cl. 380/44; 380/28

(57) ABSTRACT

Encoding radio-frequency identification (RFID) tags, each of the RFID tags having an tag identifier, t, and associated with a corresponding item, in a manner that preserves privacy of information associated with the item includes the steps of: generating a key, k; encrypting each of a plurality of tag identifiers, t, using the key, k to produce a plurality of encrypted tag identifiers; selecting a threshold value, T; dividing the key, k, into a plurality of key shares, n, such that retrieval of T or more key shares allows the key, k, to be reconstituted; and encoding each of a plurality of RFID tags with a concatenation of the encrypted tag identifier and one of the key shares, and any other data useful to reconstitute the key k.

### FIELD OF THE INVENTION

The present invention relates generally to radio-frequency identification (RFID) tags or other types of wireless identification devices and, more particularly, to techniques and apparatus for enhancing privacy of objects associated with such devices.

### BACKGROUND OF THE INVENTION

New uses for radio-frequency identification (RFID) tags continue to be found. Some examples of traditional uses for RFID tags include employee badges for providing building access and car keys that require a proper response from an RFID tag to enable vehicle operation. Due to the promise of efficient and accurate tracking of products in industrial supply chains, radio-frequency identification (RFID) tags are now under consideration as a form of next-generation barcode. Use of RFID tags to identify pallets and individual cases on pallets is already widespread. Further, several retail concerns are considering tagging individual items rather than cases and pallets containing multiple items, a practice referred to as “item level” tagging.

A conventional passive electronic product code (EPC) RFID tag typically is on the order of five to ten square centimeters in size and comprises an integrated circuit in electrical communication with an antenna. This combination is capable of transmitting a unique serial number or other information stored by the RFID tag to a nearby reader in response to a query from the reader. Nearby readers can read and write to memory provided by the RFID tag. Unfortunately, the computational resources on such EPC tags is currently quite constrained. Due to their constrained computational power, many RFID tags are unable to perform any computation to limit disclosure of their unique serial numbers or stored information to a query from any reader, including an unauthorized one.

This lack of control over disclosure of information poses an issue for deployment of RFID tags on an item-by-item basis. Because most EPC RFID protocols do not require mutual authentication between RFID readers and RFID tags, and because the standards include open specification of the data stored in the tag, the identity of tagged objects is easily ascertained and integrity of data stored on those RFID tags may be compromised. This means that a competitor may scan items in a warehouse to determine the number of items available for sale. Another problem is that a malicious user may alter the data stored in RFID tags, which creates self-evident problems for management of supply chains.

Accordingly, a need exists for techniques that solve the privacy and data integrity problems presented using RFID tags to identify cases, pallets, and individual items.

### SUMMARY OF THE INVENTION

The present invention solves the privacy problems described above using threshold cryptography techniques to encrypt pallet-level, case-level, or item-level information stored on an RFID tag. The described methods provide protection against unauthorized disclosure of information stored on a tag and protection against RFID tag counterfeiting, while requiring no changes to the air-interface protocol between tags and readers or to the tags themselves.

In one aspect, the present invention relates to a method for encoding a plurality of radio-frequency identification (RFID) tags, n, each of the n RFID tags having an tag identifier, t, and associated with a corresponding item. A key, k, is generated. Each of a plurality of n tag identifiers, t, is encrypted using the key, k, to produce a plurality of encrypted tag identifiers. A threshold number of tags, T, is selected based on the application context. The key, k, is divided into a plurality of n key shares, such that retrieval of T or more key shares allows the key, k, to be reconstituted. Each of a plurality of RFID tags is encoded with a concatenation of the encrypted tag identifier and one of the key shares. In some embodiments, the RFID tag may also be encoded with other information used to reconstitute the key.

In some embodiments, the key, k, has a bit length equal to a bit length of each of the tag identifiers, t. In other embodiments, the key, k, is 128 bits in length. In still other embodiments, the key, k, comprises a string of random bits. In further embodiments, the key, k, comprises the y-intercept of a polynomial function having degree T−1 over a Galois Field of prime order, p, where p>k. In some of these further embodiments, the key, k, is divided into a plurality of n key shares by evaluating the polynomial function at a random point.

In some embodiments, each of a plurality of tag identifiers is encrypted with a symmetric encryption algorithm using the key, k, to produce a plurality of encrypted tag identifiers. In other embodiments, the generated key, k, is associated with an identifier of a pallet, p, on which the items are loaded. In some of these other embodiments, the association between the pallet identifier and the key, k, is stored.

In another aspect, the present invention relates to an apparatus for encoding a plurality of radio-frequency identification (RFID) tags, each of the RFID tags having an tag identifier, t, and associated with a corresponding item. The apparatus includes a key source generating a key, k. An encryption engine receives the key, k, and produces a plurality of encrypted tag identifiers using the key, k. A processor identifies a threshold value, T. The threshold value, T, is selected so that at least T tags are guaranteed to be read in a particular application context. A key engine divides the key, k, into a plurality of n key shares such that retrieval of T or more key shares allows the key, k, to be reconstituted. A tag reader encodes each of a plurality of RFID tags with a concatenation of the encrypted tag identifier and one of the key shares. In other embodiments, the RFID tag may also be encoded with other information used to reconstitute the key, k.

In some embodiments, the key source generates a key, k, having a bit length equal to a bit length of each of the tag identifiers, t. In other embodiments, the key source generates a key, k, having a bit length equal to 128 bits. In still other embodiments, the key source comprises a random number generator. In still yet other embodiments, the key source generates a key, k, by determining the y-intercept of a polynomial function having degree T−1 over a Galois Field of prime order, p, where p>k. In some of these still yet further embodiments, the key engine divides the key, k, into a plurality of key shares by evaluating the polynomial function at a random point. In further embodiments, the apparatus includes a memory element storing an association between an identifier of a pallet, p, on which the items are loaded and the key, k.

### BRIEF DESCRIPTION OF THE DRAWINGS

These and other aspects of this invention will be readily apparent from the detailed description below and the appended drawings, which are meant to illustrate and not to limit the invention, and in which:

FIG. 1 is a perspective view of a typical environment including a number of items on a pallet;

FIG. 2 is a flowchart depicting one embodiment of an encoding method for protecting privacy of information associated with an RFID tag;

FIG. 3 is a flowchart depicting one embodiment of a decoding method for reading tags encoding according to FIG. 2;

FIG. 4 is a simplified block diagram of an embodiment of an RFID tag reader capable of carrying out the described methods; and

FIG. 5 is a block diagram of an embodiment of an RFID tag reader capable of carrying out the described methods.

### DETAILED DESCRIPTION

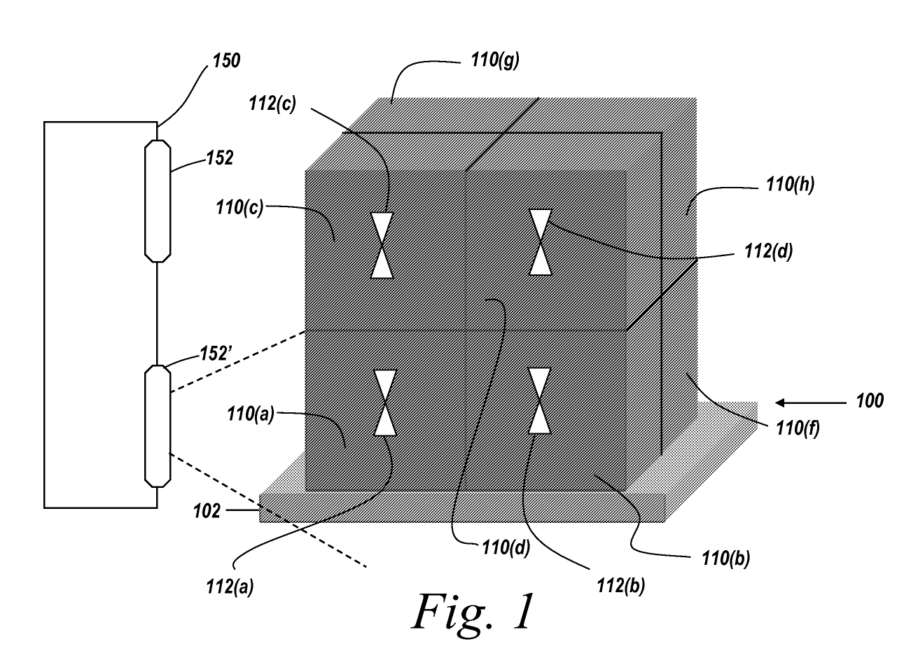

Referring now to FIG. 1, a typical environment is depicted in which RFID tags are used to identify multiple items. As shown in FIG. 1, several items 110(a)-(h) are laden on a pallet 102. Each item has affixed to it an RFID tag 112 (tags 112(e)-(h) not shown in FIG. 1). In some embodiments, the RFID tag 112 is affixed to a respective item 110 via the object's packaging. In one embodiment, the box or packaging material surrounding a consumer product may include one or more RFID tags. On a larger scale, a packing crate containing several to several hundred items may have an RFID tag affixed to it in order to effectively identify the crate. Similarly, an RFID tag may be affixed to the pallet 102 in order to uniquely identify the pallet 102.

FIG. 1 also depicts a reader system 150. Conventional RFID tag systems typically operate at a frequency of 13.56 MHz, 915 MHz, 2.45 GHz, or 125 kHz. In the embodiment shown in FIG. 1, the RFID tag reader system 150 includes one or more antenna elements 152, 152′ (generally 152) in communication with processing circuitry (not shown). The antenna elements can be any type of an antenna element. For example, the antenna elements 152 can be, but are not limited to, patch antennas, waveguide slot antennas, dipole antennas, and the like. Each antenna element of the RFID tag reader system 150 can be the same type of elements. Alternatively, the RFID tag reader system 150 incorporates two or more different types of antenna elements 152. In some embodiments, one or more of the antenna elements 304 includes a plurality of antenna elements (i.e., an array of antenna elements). In some embodiments, the antenna elements 152 are multiplexed. In other embodiments, the reader 150 may include a sense antenna (not shown), the purpose of which is to sample noise information extracted from the signals received by the sense antenna to effectively remove the sampled noise from the signals received by the receiving antenna 152, 152′ of the RFID tag reader 150.

In operation, in order to read the RFID tags 112, a QUERY command is transmitted from the reader system 150 toward the pallet of items having the RFID tags 112. Each RFID tag responds to the query by broadcasting a predetermined datum. The reader system 150 receives the responses and communicates them to the processing circuitry. In some embodiments, the RFID tag gathers power from the query signal in order to broadcast the datum. In other embodiments, the RFID tag may include a separate power source, such as a battery. However, in some cases it is unlikely that all of the tags 112 will be successfully read. This can occur because of the respective locations of the reader system 150 and the placement of the RFID tags 112 on the respective objects 110. It may also occur because of RF interference from any of a number of sources: fluorescent lights; backscattering noise produced by time-varying reflection present in the environment; legacy wireless LAN equipment; cordless telephones; other RFID readers; or other industrial, scientific, or medical devices.

The percentage of items 110 on the pallet 102 that can be reliably read, with certainty, is referred to as the system performance metric (SPM) of the pallet 102. A SPM of 64% implies that at least 64% of all items 110 on a pallet 102 can be reliably read in a typical environment. The SPM for a given pallet 102 may be used in conjunction with a cryptographic technique known as “secret sharing” to preserve the privacy of information stored in RFID tags as well as to provide some measure of protection against tag counterfeiting.

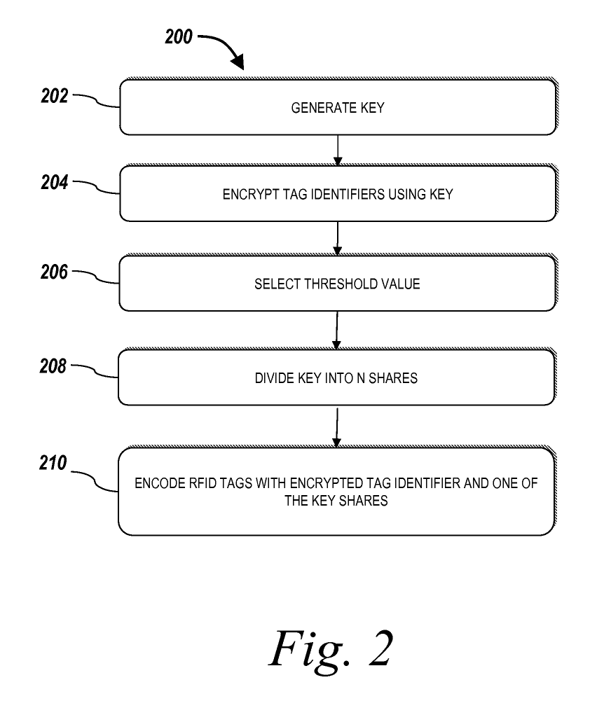

In brief overview, FIG. 2 depicts steps taken in one embodiment to encode RFID tags 112 associated with a number of items 110 on a pallet 102. A key, k, is generated (step 202) and used to encrypt the tag, t, associated with each item 110 (step 204). A threshold value, T, is selected (step 206) and the key, k, is divided into a number of key shares (step 208). Each RFID tag is then encoded with the encrypted tag identifier and a key share (step 210).

Still referring to FIG. 2, and in greater detail, an RFID tag encoding method begins by generating a key, k (step 202). The key, k, may be selected to have the same bit length as a tag identifier, or it may be selected to have a length of 56, 64, 128, 192, 256, 512, 1024 or 2056 bits. In some embodiments, the key, k, is generated by first generating a random polynomial of degree T−1 over a Galois field having prime order, p, where p is larger than bit length of the key, k. The key, k, is generated by determining the y-intercept of the polynomial. In other embodiments, the key, k, is a string of random bits.

In other embodiments, multiple keys may be generated. For example, the Electronic Product Code (EPC) data structure specifies a Domain Manager field (which is used as a manufacturer identifier), an Object Class field (equivalent to a product number), and a Serial Number (which identifies the particular item on which the tag resides). A separate key may be selected for each of these fields. Therefore, in some embodiments, a tag may be associated with up to three different keys. In these embodiments, the keys do not need to have the same length, nor do they have to be generated in the same manner. In still further of these embodiments, a “superkey” may be generated that is used to encrypt the key information associated with each field. If a “superkey” is used, a tag may be associated with up to four different keys.

The generated key, k, is used to encrypt each tag identifier, t (step 204). This creates a list of encrypted tag identifiers: {E(k, t1), E(k, t2), . . . , E(k, tn)}, where n is the number of RFID tags 112 associated with items 110 on the pallet 102. Any suitable symmetric encryption algorithm or block cipher may be used to encrypt the tag identifiers, including, without limitation, RC2, RC5, RC6, AES, DES, DESede, Triple-DES, DESX, CAST, DFC, Diamond2, E2, Anubis, Blowfish, CRYPTON, MARS, CS-CIPHER, DEAL, FROG, GOST, HPC-1, HPC-2, ICE, IDEA, LOKI, MAGENTA, MISTY1, MISTY2, Noekeon, Noekeon-Direct, Rainbow, Rijndael, SAFER-K, SAFER-SK, SAFER+, SAFER++, SERPENT, SHARK-A, SHARK-E, SKIPJACK, SPEED, SQUARE, TEA, or Twofish.

For embodiments in which multiple keys are associated with a tag, a plurality of sets of encrypted tag identifiers is created. In these embodiments, different algorithms may be used to encrypt different keys. For example, a first key associated with the Domain Manager may be encrypted using CAST-128, while the key associated with the object class may be encrypted using AES-256.

A threshold value, T, is selected (step 206). The threshold value, T, is selected to be any number less than or equal to the number of tags that can be reliably read. In some embodiments, the threshold value, T, is selected to be the largest integer less than the product of the SPM for a pallet of items 110 multiplied by the number of items 110 on the pallet 102. For example, in this embodiment a threshold value of T=70 could be selected for a pallet 102 bearing 110 items and having a SPM of 64%. In other embodiments, the threshold value may be selected to be a fraction of the product described above in order to provide a margin for error. For example, the threshold value may be selected to be 90% of the product above, or, 63.

In some embodiments, different threshold values may be selected for different EPC fields, regardless of whether a different key is generated for those fields. For example, a lower threshold value may be selected for the key used to encrypt the Domain Manager field, while a higher threshold value may be used for the key selected to encrypt the Serial Number field.

The key, k, is divided into n key shares (step 208), such that recovery of any number of key shares equal to or in excess of the threshold value, T, allows the key, k, to be reconstituted. Any of a number of well-known key sharing schemes may be used, including Shamir's scheme, Blakeley's scheme, or any one of the secret sharing schemes discussed in any one of the following publications: C. Asmuth and J. Bloom, “A Modular Approach to Key Safeguarding,” IEEE Trans. Info. Theory, Vol. IT-29, No. 2, March 1983, pp. 208-210; A. Beutelspacher and K. Vedder, “Geometric Structures as Threshold Schemes,” Proceedings of the 1987 IMA Conference on Cryptography and Coding Theory, Cirencester, England, Oxford University Press; G. R. Blakley, “Safeguarding Cryptographic Keys,” Proc. AFIPS 1979 Nat. Computer Conf., Vol. 48, New York, N.Y., June 1979, pp. 313-317; J. R. Bloom, “Threshold Schemes and Error Correcting Codes,” Am. Math. Soc., Vol. 2, 1981, pp. 230; M. De Soete and K. Vedder, “Some New Classes of Geometric Threshold Schemes,” Proc. Eurocrypt'88, May 25-27, 1988, Davos, Switzerland; A. Ecker, “Tactical Configurations and Threshold Schemes,” preprint (available from author); M. Ito, A. Saito and T. Nishizeki, “Secret Sharing Scheme Realizing General Access Structure,” (in English) Proc. IEEE Global Telecommunications Conf. Globecom'87, Tokyo, Japan, 1987, IEEE Communications Soc. Press, Washington, D.C., 1987, pp. 99-102, A. Saito and T. Nishizeki, “Multiple Assignment Scheme for Sharing Secret,” preprint (available from T. Nishizeki); E. D. Karnin, J. W. Greene and M. E. Hellman, “On Secret Sharing Systems,” IEEE International Symposium on Information Theory, Session B3 (Cryptography), Santa Monica, Calif., February 9-12, IEEE Trans. Info. Theory, Vol. IT-29, No. 1, January 1983, pp. 35-41; S. C. Kothari, “Generalized Linear Threshold Scheme,” Crypto'84, Santa Barbara, Calif., Aug. 19-22, 1984, Advances in Cryptology, Vol. 196, Ed. By G. R. Blakley and D. Chaum, Springer-Verlag, Berlin, 1985, pp. 231-241; R. J. McEliece and D. V. Sarwate, “On Sharing Secrets and Reed-Solomon Codes,” Com. ACM, Vol. 24, No. 9, September 1981, pp. 583-584; A. Shamir, “How to Share a Secret,” Massachusetts Inst. Of Tech. Tech. Rpt. MIT/LCS/TM-134, May 1979. (See also Comm. ACM, Vol. 22, No. 11, November 1979, pp. 612-613; D. R. Stinson and S. A. Vanstone, “A Combinatorial Approach to Threshold Schemes,” Cyrpto'87, Santa Barbara, Calif., Aug. 16-20, 1987, Advances in Cryptology, Ed. By Carl Pomerance, Springer-Verlag, Berlin, 1988, pp. 330-339; D. R. Stinson and S. A. Vanstone, “A Combinatorial Approach to Threshold Schemes,” SIAM J. Disc. Math, Vol. 1, No. 2, May 1988, pp. 230-236; D. R. Stinson, “Threshold Schemes from Combinatorial Designs,” submitted to the Journal of Combinatorial Mathematics and Combinatorial Computing; H. Unterwalcher, “A Department Threshold Scheme Based on Algebraic Equations,” Contributions to General Algebra, 6, Dedicated to the memory of Wilfried Nobauer, Verlag B. G. Teubner, Stuttgart (GFR), to appear December 1988; H. Unterwalcher, “Threshold Schemes Based on Systems of Equations,” Osterr. Akad. D. Wiss, Math.-Natur. K1, Sitzungsber. II, Vol. 197, 1988, to appear; H. Yamamoto, “On Secret Sharing Schemes Using (k. L, n) Threshold Scheme,” Trans. IECE Japan, vol. J68-A, No. 9, 1985, pp. 945-952, (in Japanese) English translation available from G. J. Simmons; T. Uehara, T. Nishizeki, E. Okamoto and K. Nakamura, “Secret Sharing Systems with Matroidal Schemes,” Trans. IECE Japan, Vol. J69-A, No. 9, 1986, pp. 1124-1132, (in Japanese; English translation available from G. J. Simmons). English summary by Takao Nishizeki available as Tech. Rept. TRECIS8601, Dept. of Elect. Communs., Tohoku University, 1986. In some embodiments, each key share has the same bit length as the original key. For embodiments in which the key, k, is derived from a random polynomial of GF(p), the key shares may be created by evaluating the polynomial at random points.

Each RFID tag 112 is coded with its encrypted tag identifier, E(k, t) and a key share. In some embodiments, these values are concatenated and stored in a single memory location on the tag. In other embodiments, each RFID tag 112 may be encoded with its encrypted tag identifier, E(k, t), a key share, and any other information required to reconstitute the key, k. For example, in embodiments in which the key share is selected by evaluating at random points a polynomial of GF(p), the RFID tags may be encoded with the encrypted tag identifier, E(k, t), a key share, and the x-coordinate value used to evaluate the polynomial. For embodiments in which multiple keys are used to encrypt multiple EPC fields, the tag may be encoded with each key share associated with each of the multiple keys.

For embodiments in which an RFID tag is associated with the pallet 102, an association between the pallet id stored by the pallet RFID tag and the generated key, k, may be stored. In others of these embodiments, the pallet id may be stored with an identification of the secret-recovery scheme to be used for the pallet 102 with which the pallet id is associated.

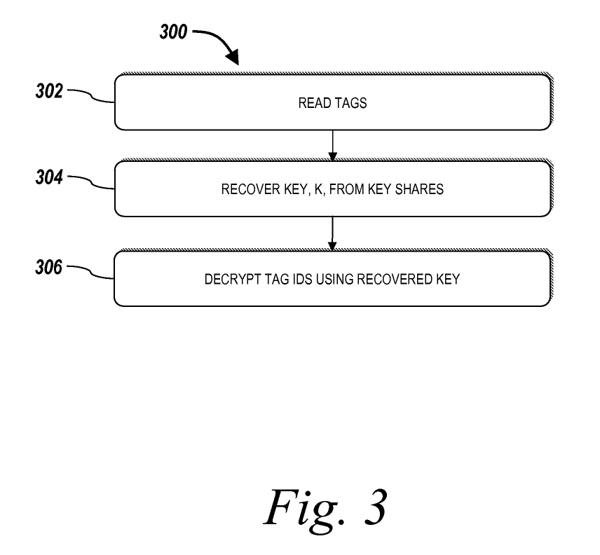

Referring now to FIG. 3, one embodiment of the steps taken to read the RFID tags 112 on the items 110 and recover the key, k, from a number of key shares is shown. An RFID tag reader 150 reads as many of the item tags 112 as possible (step 302). The number of successfully read tags will be the product of the number of items 110 on the pallet 102 times the SPM for the pallet 102. The reader uses the recovered key shares to reconstitute the key, k, for the items 110 on the pallet 102 (step 304). Using the reconstituted key, k, the reader decrypts the tag identifiers (step 306).

In some embodiments, the RFID tag reader successfully reads more RFID tags than the minimum number necessary to reconstitute the key, k. In these embodiments, the reader may verify the reconstituted key, k, by using the secret-recovery scheme multiple times, each time using a different, minimal set of key shares. For embodiments in which the pallet id is stored, it may be used to identify the particular pallet 102 and specify a secret-recovery scheme to be used.

Once the items 110 have been unloaded from the pallet 102, an unauthorized reader (i.e., one without access to the key, k) is unable to read the RFID tags 112 on an item 110 without the ability to successfully read a number of RFID tags sufficient to allow reconstitution of the key, k. The concatenation of the encrypted tag identifier and the key share stored by an RFID tag appears as random information, which makes the probability of successful secret prediction (and, therefore, tag counterfeiting) 2-b, where b is the number of bits in the concatenation.

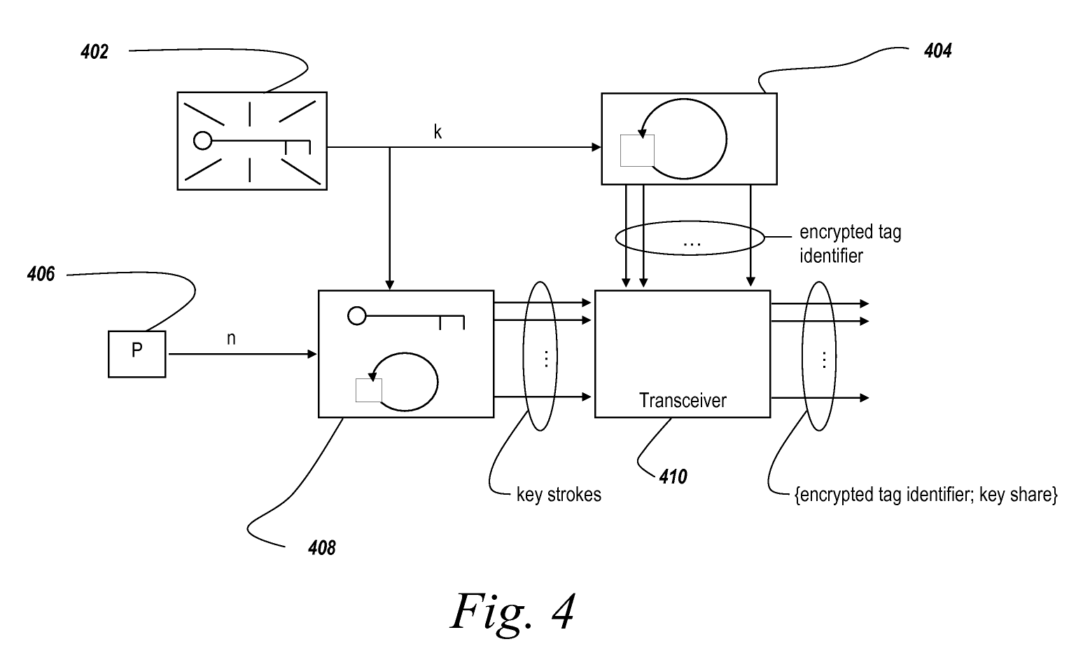

FIG. 4 depicts one embodiment of a reader useful in carrying out the steps described above. As shown in FIG. 4, the reader includes a key generator 402, encryption engine 404, processor 406, key share generator 408 and transceiver 410. One or more of these elements may be implemented in whole or in part as a conventional microprocessor, digital signal processor, application-specific integrated circuit (ASIC) or other type of circuitry, as well as portions or combinations of such circuitry elements. In some embodiments, one or more of the elements may be provided as software executing on a processor, such as a central processing unit, microcontroller, or programmable digital signal processor. Software programs for controlling the operation of the reader may be stored in memory and executed by the processor. For example, software specifying the steps taken to implement certain encryption algorithms may be stored in the memory and executed by the processor.

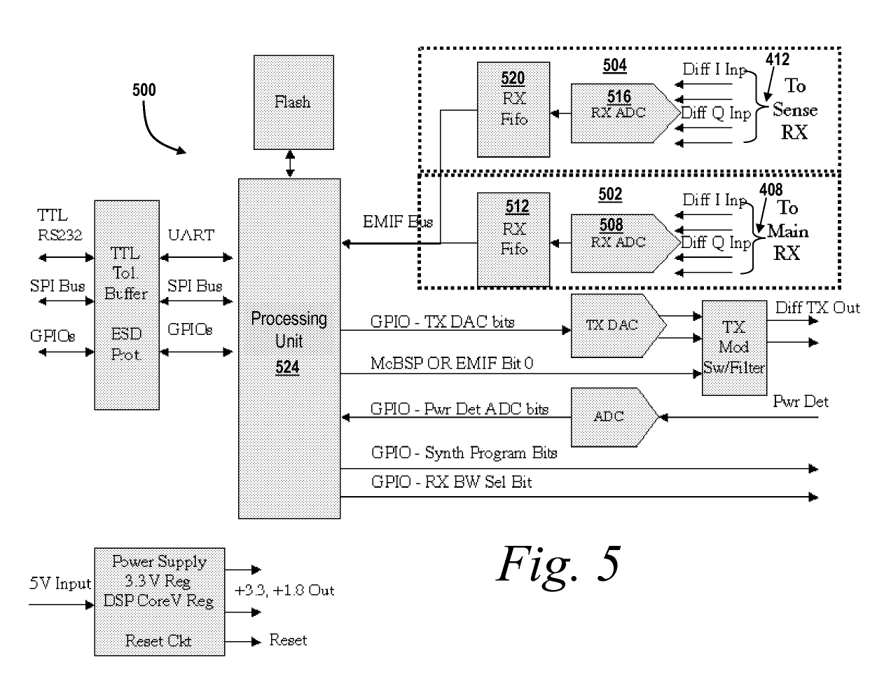

With reference to FIG. 5, another embodiment of a suitable reader is shown, which includes a main digital receiver section 502 and an optional sense digital receiver section 504. In one embodiment, the main digital receiver section 502 includes an analog to digital converter 508 (RX ADC) in communication with the main reader circuitry of the reader that receives analog response signals from the main reader circuitry. The RX ADC 508 also communicates with a first-in-first-out (RX FIFO) memory 512. Although shown as having a single ADC 508, other embodiments can include additional RX ADCs 508 can be used. For example, each of the in-phase signal and quadrature signals can be fed into a respective ADC 508. Also, additional FIFO memories 512 can be used to store each of the respective digitized signals.

The sense digital receiver section 504 includes an analog to digital converter 516 (RX ADC) that communicates with the main reader circuitry of the reader to receive analog noise and interference signals from the reader circuitry. The RX ADC 516 communicates with a first-in-first-out (FIFO) memory 520. In other embodiments, the RX ADC 516 communicates with an FPGA (not shown). Although shown as having a single RX ADC 508, it should be understood that additional RX ADCs 508 can be used. For example, each of the in-phase signal and quadrature signals can be fed into a respective RX ADC 508. Also, additional FIFO memories 520 can be used to store each of the respective digitized signals.

In operation in the responses to the QUERY command, the reader antenna signals are received and digitized, the digitized signals are communicated to processing unit 524 (e.g., a digital signal processor (DSP)). In some embodiments, the processing unit 524 periodically accesses the FIFO memories, retrieves the digitized signals, and processes the digital signals. The processing unit 524 performs additional processing on the digitized response signal to classify each slot 100 of the inventory round accordingly.

In one embodiment, the processing unit 524 is a DSP. In another embodiment, the processing unit 524 is a field programmable gate array (FPGA). In another embodiment, one or more application specific integrated circuits (ASIC) are used. Also, various microprocessors can be used in some embodiments. In other embodiments, multiple DSPs are used along or in combination with various numbers of FPGAs. Similarly, multiple FPGAs can be used. In one specific embodiment, the processing unit 524 is a BLACKFIN DSP processor manufactured by Analog Devices, Inc. of Norwood, Mass. In another embodiment, the processing unit 524 is a TI c5502 processor manufactured by Texas Instruments Inc. of Dallas Tex.

In this embodiment, instructions for generating keys, k, encrypting and decrypting tag identifiers, and generating key shares may be stored in the flash memory associated with the processor 524 and fetched from the memory by processor 524 for execution. For example, in some embodiments the memory stores instruction for generating random numbers. Those instructions may be fetched by the processor 524 and executed to generate a key, K. The memory element may also be used to store information such as associations between pallet identifiers and keys or pallet identifiers and secret-recovery schemes.

In other embodiments, the key generator 402, encryption engine 404 and key share generator 408 may be separate from the reader. In these embodiments, the flash memory may store key shares received from the key share generator. In specific ones of these embodiments, the key shares may be received as a file.

The methods and apparatus described above may be used in a manner to detect whether tag information has been counterfeited and also to detect whether a stray item (counterfeited or not) has been mixed in with a set of items. This can be accomplished by selecting a threshold value, T, which is less than the number of tags that can be expected to be reliably read from a pallet. Using the example above, on a pallet of 110 items having an SPM of 64%, 70 tags will be reliably read. If a threshold value, T, of less than 70 is chosen, a tag reader will reliably read a number of tags in excess of the threshold value, T. This allows multiple reconstitutions of the key using subsets the successfully read tag values. For example, if 70 tags are read and the threshold value, T=50, there are “70 choose 50” subsets of tag values that may be used to reconstitute the key. If any one of the subsets yields an incorrect reconstituted key value, that subset includes a stray or counterfeit tag. Further subsets can then be selected to identify, with particularity, the offending tag.

The invention has been described with respect to preferred embodiments; however, the methods and systems of the present invention are not limited to the preferred embodiments. The skilled artisan will readily appreciate that various omissions, additions and modifications can be made to the methods and systems described above without departing from the scope of the invention, and all such modifications and changes are intended to fall within the scope of the invention, as defined by the appended claims.

What is claimed is:

1. A method for encoding a plurality of radio-frequency identification (RFID) tags, each of the RFID tags having a tag identifier, t, the method comprising:
(a) generating a key, k;
(b) encrypting each of a plurality of tag identifiers, t, using the key, k, to produce a plurality of encrypted tag identifiers;
(c) selecting a threshold value, T less than the number of tag identifiers comprising the plurality of tag identifiers;
(d) dividing the key, k, into a plurality of key shares, n, such that retrieval of T or more key shares allows the key, k, to be reconstituted; and
(e) encoding each of the plurality of RFID tags with a concatenation of the encrypted tag identifier and one of the key shares.

2. The method of claim 1 wherein step (a) comprises generating a key, k, having a data length in bits equal to a data length in bits of each of the tag identifiers, t.

3. The method of claim 1 wherein step (a) comprises generating a key, k, having a bit length equal to 128 bits.

4. The method of claim 1 wherein step (a) comprises generating a string of random bits.

5. The method of claim 1 wherein step (a) comprises generating a key, k, by determining the y-intercept of a polynomial function having degree T−1 over a Galois Field of prime order, p, where p>k.

6. The method of claim 5 wherein step (d) comprises dividing the key, k, into a plurality of key shares, each of the key shares produced by evaluating the polynomial function at a random point.

7. The method of claim 5 wherein step (e) comprises encoding each of a plurality of RFID tags with a concatenation of the encrypted tag identifier, one of the key shares, and an x-coordinate associated with the random point at which the polynomial was evaluated to produce the key share.

8. The method of claim 1 wherein step (b) comprises encrypting each of a plurality of tag identifiers, t, with a symmetric encryption algorithm using the key, k, to produce a plurality of encrypted tag identifiers.

9. The method of claim 1 wherein step (c) comprises selecting a threshold value, T, to be less than or equal to the greatest integer less than the number of tags likely to be readable from a given plurality of tags.

10. The method of claim 1 wherein step (e) comprises encoding each of a plurality of RFID tags with a concatenation of the encrypted tag identifier, one of the key shares, and other data useful for reconstituting the key, k.

11. The method of claim 1 further comprising the step of associating the generated key, k, with an identifier of a pallet, p, on which the items are loaded.

12. The method of claim 8 further comprising storing the association between the pallet identifier, p, and the key, k.

13. An apparatus for encoding a plurality of radio-frequency identification (RFID) tags, each of the RFID tags having a tag identifier, t, and associated with a corresponding item, the apparatus comprising:
a key source generating a key, k;
an encryption engine in communication with the key source, the encryption engine producing a plurality of encrypted tag identifiers using the key, k, generated by the key source;
a processor identifying a threshold value, T, wherein T is less than the number of tag identifiers;
a key engine dividing the key, k, into a plurality of key shares, n, such that retrieval of T or more key shares allows the key, k, to be reconstituted; and
a tag reader encoding each of a plurality of RFID tags with a concatenation of the encrypted tag identifier and one of the key shares.

14. The apparatus of claim 13 wherein the key source generates a key, k, having a bit length equal to a bit length of each of the tag identifiers, t.

15. The apparatus of claim 13 wherein the key source generates a key, k, having a bit length equal to 128 bits.

16. The apparatus of claim 13 wherein the key source comprises a random number generator.

17. The apparatus of claim 13 wherein the key source generates a key, k, by determining the y-intercept of a polynomial function having degree T−1 over a Galois Field of prime order, p, where p>k.

18. The apparatus of claim 17 wherein the tag reader encodes each of a plurality of RFID tags with a concatenation of the encrypted tag identifier, one of the key shares, and an x-coordinate associated with determined y-intercept of the polynomial function.

19. The apparatus of claim 17 wherein the key engine divides the key, k, into a plurality of key shares, each of the key shares produced by evaluating the polynomial function at a random point.

20. The apparatus of claim 13 further comprising a memory element storing an association between an identifier of a pallet, p, on which the items are loaded and the key, k.

21. The apparatus of claim 13 wherein the processor identifies a threshold value, T, wherein T is less than or equal to the number of tags likely to be readable from a given plurality of tags.

22. The apparatus of claim 13 wherein the tag reader encodes each of a plurality of RFID tags with a concatenation of the encrypted tag identifier, one of the key shares, and other data useful to reconstitute the key, k.

23. An apparatus for encoding a plurality of radio-frequency identification (RFID) tags, each of the RFID tags having a tag identifier, t, the apparatus comprising:
(a) means for generating a key, k;
(b) means for encrypting each of a plurality of tag identifiers, t, using the key, k, to produce a plurality of encrypted tag identifiers;
(c) means for selecting a threshold value, T less than the number of tag identifiers comprising the plurality of tag identifiers;
(d) means for dividing the key, k, into a plurality of key shares, n, such that retrieval of T or more key shares allows the key, k, to be reconstituted; and
(e) means for encoding each of the plurality of RFID tags with a concatenation of the encrypted tag identifier and one of the key shares.

24. The apparatus of claim 23 wherein the generating means comprises means for generating a key, k, having a data length in bits equal to a data length in bits of each of the tag identifiers, t.

25. The method of claim 23 wherein the generating means comprises means for generating a key, k, having a bit length equal to 128 bits.

26. The method of claim 23 wherein the generating means comprises means for generating a string of random bits.

27. The method of claim 23 wherein the generating means comprises means for generating a key, k, by determining the y-intercept of a polynomial function having degree T−1 over a Galois Field of prime order, p, where p>k.

28. The method of claim 27 wherein the dividing means comprises means for dividing the key, k, into a plurality of key shares, each of the key shares produced by evaluating the polynomial function at a random point.

29. The method of claim 27 wherein the encoding means comprises the means for encoding each of a plurality of RFID tags with a concatenation of the encrypted tag identifier, one of a plurality of RFID tags with a concatenation of the encrypted tag identifier, one of the key shares, and an x-coordinate associated with the random point at which the polynomial was evaluated to produce the key share.

30. The method of claim 23 wherein the encrypting means comprises means for encrypting each of a plurality of tag identifiers, t, with a symmetric encryption algorithm using the key, k, to produce a plurality of encrypted tag identifiers.

31. The method of claim 23 wherein the selecting means comprises means for selecting a threshold value, T, to be less than or equal to the greatest integer less than the number of tags likely to be readable from a given plurality of tags.

32. The method of claim 23 wherein the encoding means comprises means for encoding each of a plurality of RFID tags with a concatenation of the encrypted tag identifier, one of the key shares, and other data useful for reconstituting the key, k.

33. The method of claim 23 further comprising means for associating the generated key, k, with an identifier of a pallet, p, on which the items are loaded.

34. The method of claim 33 further comprising means for storing the association between the pallet identifier, p, and the key, k.
